(19) United States
(12) Patent Application Publication
(10) Pub. No.: US 2018/0261018 A1
(43) Pub. Date: Sep. 13, 2018

(54) MOTORWAY TOLL SYSTEM AND METHOD FOR GRANTING ACCESS OF A USER VEHICLE TO A MOTORWAY

(71) Applicant: SANEF, Issy-Les-Moulineaux (FR)

(72) Inventors: Lionel Reinold, Venette (FR); Jacques Gielblat, Boissise le Roi (FR); Sylvain Davrou, Verneuil-En-Hal (FR); Guy Fremont, Paris (FR); Edouard Fischer, Issy-Les-Moulineaux (FR)

(21) Appl. No.: 15/916,587

(22) Filed: Mar. 9, 2018

(30) Foreign Application Priority Data
Mar. 10, 2017 (FR) 1751985

(51) Int. Cl. G07B 15/06; G06Q 20/32; G06Q 20/38; G06Q 20/36

(52) U.S. Cl. CPC G07B 15/063; G06Q 20/3278; G06Q 20/3674; G06Q 20/3829; G06Q 20/3224

(57) ABSTRACT

Motorway toll method and device capable of authorizing access to a motorway for a user's vehicle using a toll lane of a motorway infrastructure using a mobile terminal storing a dedicated application, the method including a step to awaken the dedicated application, a geopositioning step of the mobile terminal and an identification step that includes identifying the user, the user identification generating an authorisation for the vehicle to access the motorway.

### TECHNICAL DOMAIN

This invention relates to the subject of motorway tolls. More particularly, it relates to a motorway toll method and system capable of authorising access of a user's vehicle to a motorway.

### STATE OF PRIOR ART

It is known that motorway tolls (or toll stations) comprise a plurality of toll lanes closed by toll barriers. Each toll lane usually comprises a payment terminal or machine on which a transaction can be made to trigger opening of the toll barrier.

Conventionally, payment to trigger opening of the toll barrier is made by cash or bank card, for example contactless using the NFC (Near Field Communication) technology. These techniques require that the vehicle stops to make the payment, which has the disadvantage that it slows motorway traffic at the toll station and can cause traffic jams, particularly during busy periods.

### PRESENTATION OF THE INVENTION

The purpose of this invention is to overcome this disadvantage by disclosing a payment method and device allowing passage through the toll station in “hands free” mode and with the shortest possible stop, or possibly even without stopping respecting installed signs.

To achieve this, the invention relates to a motorway toll method capable of authorising access to a motorway for a user's vehicle using a toll lane of a motorway infrastructure using a mobile terminal located in the vehicle, the motorway infrastructure comprising a plurality of toll lanes, the mobile terminal containing a transmission-reception module, a processor and a memory storing a dedicated application, the dedicated application being implemented as a background task by the processor.

According to the invention, the method includes the following steps:

a step to awaken the dedicated application when the vehicle approaches the toll lane, said awakening step being implemented by a monitoring module of the dedicated application, consisting of starting the dedicated application on reception of a first signal through the transmission-reception module of the mobile terminal, the first signal being transmitted by a first beacon in the toll lane used by the vehicle;

a geopositioning step of the mobile terminal at the time that the vehicle approaches the motorway infrastructure, said geopositioning step being implemented by a geopositioning module of the dedicated application and consisting of determining the geoposition of the mobile terminal so as to geoposition the vehicle in the toll lane, using at least the first signal received from the first beacon;

if the geopositioning step has determined a geoposition of the mobile terminal in the toll lane facing a toll barrier in the toll lane used by the vehicle, the method includes:

an identification step, implemented by an identification assembly consisting of making a user identification, the user identification generating an authorisation for the vehicle to access the motorway.

Due to the monitoring module and the geopositioning module, the vehicle that might use a toll lane is geopositioned at the time that it approaches the motorway infrastructure. As soon as the vehicle has been geopositioned in a toll lane, the identification module can identify the user.

Since the vehicle is geopositioned by means of the mobile terminal without the user needing to approach the payment means, the vehicle user does not need to hold his mobile terminal in his hand to determine whether or not the vehicle can access the motorway; he must respect the signs that might ask him to slow down or to stop.

Furthermore, the transmission-reception module of the mobile terminal is configured to function with a protocol using the short range two-directional transmission technique known as “Bluetooth Low Energy”.

Furthermore, the first signal transmitted by the first beacon comprises information including at least one toll lane identifier and the position of the first beacon.

According to a first embodiment, the geopositioning step includes the following sub-steps:

a reception sub-step, implemented by the transmission-reception to module of the mobile terminal, consisting of receiving at least one second signal transmitted by a second beacon and a third signal transmitted by a third beacon, the second signal and the third signal comprising information containing at least one toll lane identifier and the corresponding positions of the second beacon and the third beacon respectively;

a calculation sub-step implemented by the geopositioning module of the dedicated application, consisting of calculating the geoposition of the mobile terminal by triangulation starting from the corresponding positions of beacons with the same toll lane identifier, said positions being deduced from the first, second and third received signals.

According to a second embodiment, the geopositioning step includes the following sub-steps:

a reception sub-step implemented by the transmission-reception module of the mobile terminal, consisting of receiving a signal transmitted by a directional antenna of a transmission device associated with the toll lane used by the vehicle, the directional antenna transmitting a signal only in the toll lane, the signal comprising information containing at least the toll lane identifier;

a calculation sub-step, implemented by the geopositioning module of the dedicated application, consisting of determining the geoposition of the mobile terminal, the mobile terminal being geopositioned in the toll lane used by the vehicle when the identifier of the toll lane included in the signal transmitted by the directional antenna corresponds to the identifier of the toll lane included in the signal transmitted by the first beacon.

The identification step includes the following sub-steps:

a sub-step to authenticate the motorway infrastructure by the mobile terminal consisting of authenticating the motorway infrastructure by sending at least one token and a first electronic signature generated from the token, the token and the first signature being sent by the motorway infrastructure to the mobile terminal;

a sub-step to authenticate the mobile terminal by the motorway infrastructure consisting of authenticating the mobile terminal by sending at least one second electronic signature generated from the token, the second signature being sent by the mobile terminal to the motorway infrastructure;

an authorisation sub-step implemented by a motorway infrastructure server calculation module, consisting of implementing one of the following two actions:
if the motorway infrastructure server calculation module deduces that the second signature is generated from said token, the motorway infrastructure server sends a signal representing an access authorisation for the vehicle,
if the motorway infrastructure server calculation module deduces that the second signature is not generated from said token, the motorway infrastructure server sends a signal representing a refusal to allow access for the vehicle,

Furthermore, the motorway infrastructure authentication sub-step by the mobile terminal comprises:

a first sub-step to send the identifier, implemented by the transmission-reception module of the mobile terminal, consisting of sending a signal representative of a unique payment identifier, the signal being sent to the motorway infrastructure server;

a token generation sub-step, implemented by the motorway infrastructure server calculation module, consisting of generating a token representative of information for a transaction to be authorised:

a sub-step to generate a first signature, implemented by the motorway infrastructure server calculation module, consisting of generating a first signature starting from the token by encrypting the token using a first private key of the motorway infrastructure server, the first private key of the motorway infrastructure server being stored in a secure memory of the motorway infrastructure server;

a reception sub-step, implemented by the transmission-reception module of the mobile terminal, consisting of receiving the token and the first signature generated by the motorway infrastructure server calculation module;

a first decryption sub-step, implemented by a secure module of the mobile terminal, consisting of decrypting the first signature using a public key of the motorway infrastructure server, the public key of the motorway infrastructure server being stored in a secure memory of the mobile terminal.

Furthermore, the sub-step to authenticate the mobile terminal by the motorway infrastructure comprises:

a sub-step to generate a second signature, implemented by the secure module of the mobile terminal, consisting of generating a second signature by encrypting the token by a derived private key concerning the mobile terminal;

a second send sub-step, implemented by the transmission-reception module of the mobile terminal, consisting of sending the second signature to the motorway infrastructure server;

a second decryption sub-step, implemented by the motorway infrastructure server calculation module, consisting of decrypting the second signature by a derived public key concerning the mobile terminal.

Furthermore, the authorisation sub-step implemented by the motorway infrastructure server calculation module also comprises:

if the motorway infrastructure server calculation module deduces that the second signature is generated from the token, the motorway infrastructure server sends a signal representing a transaction authorisation to a supplier server,

if the motorway infrastructure server calculation module deduces that the decrypted second signature is not generated from the token, the motorway infrastructure server sends a signal representing a transaction refusal to the supplier server,

Advantageously, the sub-step to authenticate the mobile terminal by to the motorway infrastructure also comprises:

a sub-step to generate the derived public key comprising:
a sub-step to send a public key from the motorway infrastructure server by said motorway infrastructure server to a supplier server;
a sub-step to generate a master public key and a master private key by a supplier server calculation module;
a sub-step to send the master public key by the supplier server to the secure memory of the motorway infrastructure server;
a sub-step to calculate the public key derived from the unique payment identifier and the master public key by the motorway infrastructure server calculation module.

The sub-step to authenticate the mobile terminal by the motorway infrastructure also comprising:

a sub-step to generate the derived private key comprising:
a sub-step to generate the unique payment identifier by the supplier server calculation module and to send the unique payment identifier to the mobile terminal;
a sub-step to calculate the private key derived by the supplier server calculation module from the unique payment identifier and the master private key;
a sub-step to send the derived private key and the public key by the supplier server to the secure memory of the mobile terminal.

According to one special feature, the method includes a degraded mode operating step, implemented by a degraded mode operating module, consisting of replacing the transmission-reception module by an auxiliary transmission-reception module.

The invention also relates to a motorway toll system capable of authorising access to a motorway for a vehicle of a user using a toll lane of a motorway infrastructure using a mobile terminal located in the vehicle, the motorway infrastructure comprising a plurality of toll lanes, the mobile terminal containing a transmission-reception module, a processor and a memory storing a dedicated application, the dedicated application being implemented as a background task by the processor.

According to the invention, the system comprises:

at least one first beacon for each toll lane, the first beacon(s) being configured to transmit a first signal;

a monitoring module of the dedicated application configured to start the dedicated application upon reception of the first signal by the transmission-reception module of the mobile terminal when the vehicle approaches the toll lane, the first signal being transmitted by the first beacon in the toll lane used by the vehicle;

a geopositioning module of the dedicated application configured to determine the geoposition of the mobile terminal when the vehicle is approaching the motorway infrastructure, so as to geoposition the vehicle in the toll lane, using at least the first signal received from the first beacon;

an identification assembly configured to identify the user if the geopositioning module has determined a geoposition of the mobile terminal in the toll lane facing a toll barrier of the toll lane used by the vehicle, identification of the user generating authorisation for the vehicle to access the motorway.

Furthermore, the transmission-reception module of the mobile terminal is configured to function with the protocol using the short range two-directional transmission technique known as “Bluetooth Low Energy”.

Furthermore, the first signal transmitted by the first beacon comprises information including at least one toll lane identifier and the position of the first beacon.

According to a first embodiment, the system comprises:

at least one second beacon and one third beacon arranged in the motorway infrastructure, the second beacon being configured to transmit a to second signal, the third beacon being configured to transmit a third signal, the second signal and the third signal comprising information containing at least one toll lane identifier and the positions of the second beacon and the third beacon respectively;

the geopositioning module of the dedicated application being configured to calculate the geoposition of the mobile terminal by triangulation starting from the corresponding positions of beacons with the same toll lane identifier.

According to a second embodiment, the system comprises:

a directional antenna of a transmission device associated with the toll lane used by the vehicle, the directional antenna being configured to transmit a signal only in the toll lane, the signal comprising information containing at least the toll lane identifier;

the geopositioning module of the dedicated application being configured to determine the geoposition of the mobile terminal, the mobile terminal being geopositioned in the toll lane used by the vehicle when the toll lane identifier included in the signal transmitted by the directional antenna corresponds to the identifier of the toll lane included in the signal transmitted by the first beacon.

According to one special feature, the system comprises a degraded mode operating module, configured to replace the transmission-reception module by an auxiliary transmission-reception module.

### BRIEF DESCRIPTION OF THE FIGURES

The invention and its characteristics and advantages will become clearer after reading the description with reference to the appended drawings in which:

FIG. 1 represents one embodiment of a toll lane of a motorway infrastructure used by a vehicle;

FIG. 2 diagrammatically represents one embodiment of a mobile terminal;

FIG. 3 diagrammatically represents one embodiment of a motorway infrastructure server;

FIG. 4 diagrammatically represents one embodiment of a supplier server;

FIG. 5 represent a diagram representing exchanges between the different components of the system;

FIG. 6 diagrammatically represents the steps in the method.

### DETAILED DESCRIPTION

The remaining part of the description will be made with reference to the figures mentioned above.

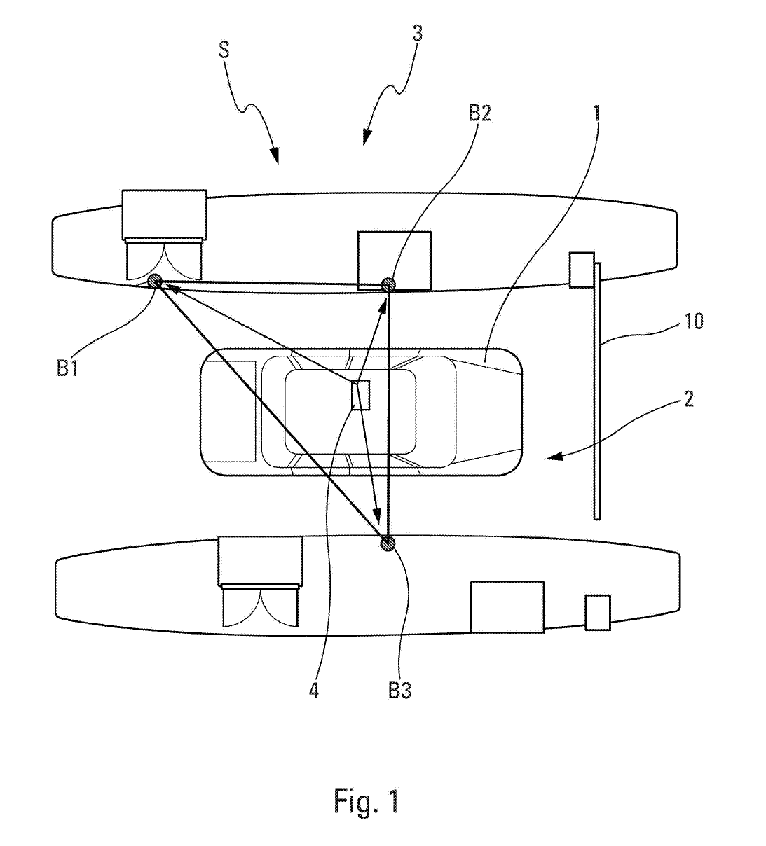

The invention relates to a motorway toll method and system S capable of authorising a vehicle 1 to access a motorway, particularly an automobile vehicle of a user using a toll lane 2 of a motorway infrastructure 3 comprising a plurality of toll lanes 2 (FIG. 1).

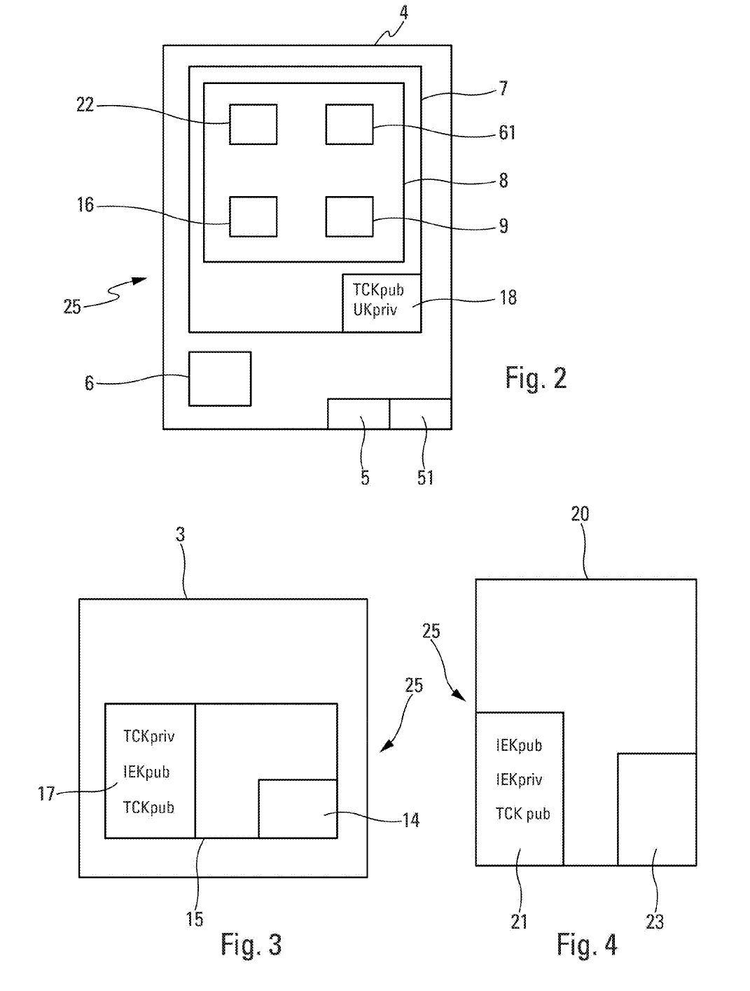

The access authorisation is given using a mobile terminal 4 in operation located inside the vehicle 1. As shown on FIG. 2, the mobile terminal 4 contains a transmission-reception module 5, a processor 6 and a memory 7 storing a dedicated application 8. The dedicated application is run as a background task by the processor 6.

Preferably, the transmission-reception module 5 of the mobile terminal 4 is configured to function with the protocol using the short range two-directional transmission technique known as “Bluetooth Low Energy”. Obviously, the transmission-reception module 5 may be configured to operate with another equivalent protocol.

The system S comprises a monitoring module 61 of the dedicated application 8, configured to start the dedicated application 8 on reception of a first signal S1 by the transmission-reception module 5 of the mobile terminal 4. The system S comprises at least one first beacon B1 for each toll lane 2. Each of the first beacons B1 is configured to transmit (or send) the first signal S1.

Thus, when a vehicle 1 approaches the toll lane 2, the first signal S1 transmitted by the first beacon B1 associated with the toll lane 2 used by the vehicle 1 is used to start the dedicated application 8.

Starting the dedicated application 8 means that the operating system of the mobile terminal 4 authorises execution of the steps implemented by the dedicated application 8 and provides a memory space of mobile terminal 4 to enable execution of the steps.

Advantageously, the first signal S1 transmitted by the first beacon B1 comprises information containing at least one identifier of the toll lane 2 and the position of the first beacon B1. The information contained in the first S1 can also include a Universally Unique IDentifier (UUID) of a part of a motorway network.

The system S also comprises a geopositioning module 9 of the dedicated application 8, configured to determine geopositioning of the mobile terminal 4, using at least one first signal S1 received from the first beacon B1.

The first signal S1 that enables the dedicated application 8 to start may be the first signal S1 from a first beacon B1 that is not associated with the toll lane 2 that the vehicle 1 intends to use. The geopositioning module 9 determines the toll lane 2 used by the vehicle 1.

According to a first embodiment, the system S comprises at least one second beacon B2 and a third beacon B3 arranged as part of the motorway infrastructure 3. In the example in FIG. 1, the second beacon B2 and the third beacon B3 are located on opposite sides of the toll lane 2. The second beacon B2 is configured to transmit a second signal S2. The third beacon B3 is configured to transmit a third signal S3. The transmission-reception module 5 of the mobile terminal 4 receives the second signal S2 transmitted by the second beacon B2 and the third signal S3 transmitted by the third beacon B3.

Advantageously, if the transmission-reception module 5 receives several first signals S1 from different first beacons B1 in several toll lanes 2, the geopositioning module 9 can consider the highest average of these signals S1, S2 and S3. To determine the set of three beacons B1, B2 and B3 that correspond to the closest beacons, the geopositioning module 9 considers the intensity of each of the signals S1, S2 and S3 received by the transmission-reception module 5. In general, the closest beacon corresponds to the received signal for which the intensity at the mobile terminal 4 is highest.

The second signal S2 and the third signal S3 comprise information containing at least one identifier of the toll lane 2 and corresponding positions of the second beacon B2 and the third beacon B3. As for the first beacon B1, the information contained in the second signal S2 and the third signal S3 may also each comprise a universally unique identifier of the part of the motorway network concerned.

The geopositioning module 9 can be used to calculate the geoposition of the mobile terminal 4 by triangulation starting from the corresponding positions of the beacons B1, B2, B3 with the same identifier of the toll lane 2. The positions of beacons B1, B2, B3 and the identifier of the toll lane 2 are deduced from the signals S1, S2, S3 transmitted by the beacons B1, B2, B3 respectively.

Knowing that the intensity of a signal is inversely proportional to the square of the distance between a beacon B1, B2, B3 and the transmission-reception module 5 of the mobile terminal 4, the triangulation calculation can be made using the measurement of the intensity of each of the signals S1, S2, S3 made by the transmission-reception module 5 of the mobile terminal 4.

The system S may include more than three beacons to improve the precision of geopositioning.

According to a second embodiment (not shown), the system S comprises a transmission device provided with a directional antenna. The transmission device is configured to send a signal SA that can be transmitted by the directional antenna. The transmission-reception module 5 of the mobile terminal 4 receives the signal SA transmitted by the directional antenna of the transmission device associated with the toll lane 2 used by the vehicle 1.

Advantageously, if the transmission-reception module 5 receives several first signals S1 from different beacons B1 for several toll lanes 2, the geopositioning module 9 considers the first signal S1 transmitted by the closest first beacon B1. To determine the first beacon B1 that correspond to the closest first beacon B1, the geopositioning module 9 considers the intensity of each of the first signals S1 received by the transmission-reception module 5. In general, the closest first beacon B1 corresponds to the received first signal S1 for which the intensity at the mobile terminal 4 is highest.

The directional antenna transmits a signal SA only in the toll lane 2. The signal SA transmitted by the directional antenna comprises information containing at least the identifier of the toll lane 2.

In this embodiment, the geopositioning module 9 of the dedicated application 8 can be used to determine the geoposition of the mobile terminal 4. The mobile terminal 4 is geopositioned in the toll lane 2 used by the vehicle 1 when the identifier of the toll lane 2 included in the signal SA transmitted by the directional antenna corresponds to the identifier of the toll lane 2 included in the signal S1 transmitted by the first beacon B1.

The system S also comprises an identification assembly 25, configured to make a user identification, if the geopositioning module 9 has determined the geoposition of the mobile terminal 4 in the toll lane 2 facing a to toll barrier 10 of the toll lane 2 used by the vehicle 1.

The system S also comprises a server 15 forming part of the motorway infrastructure 3 (FIG. 3). The server 15 of the motorway infrastructure 3 is provided with a calculation module 14.

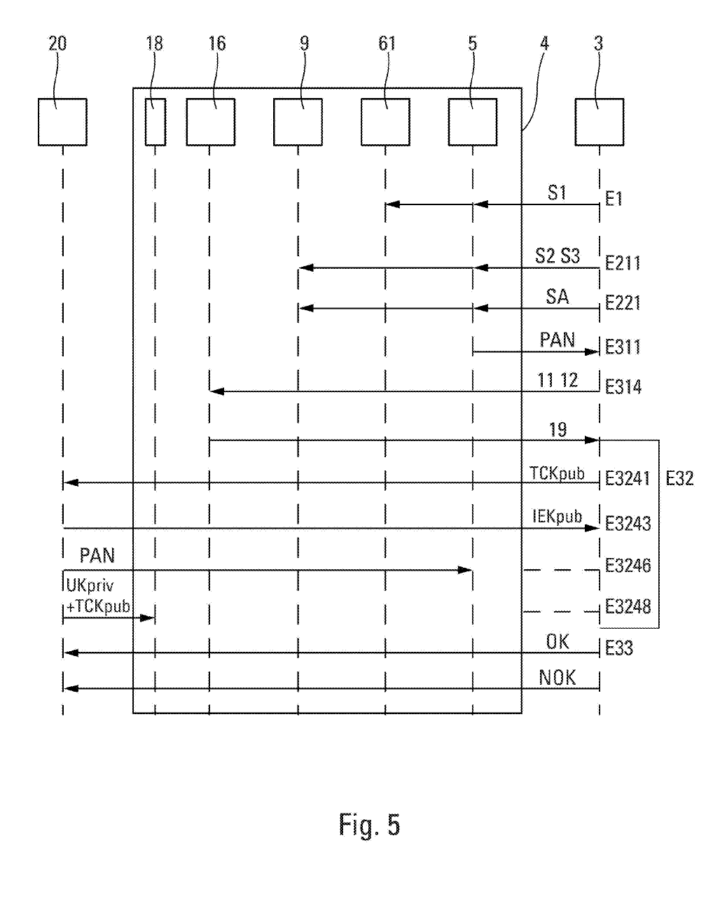

The identification assembly 25 is configured such that the mobile terminal 4 authenticates the motorway infrastructure 3. To achieve this, the motorway infrastructure 3 sends at least one token 11 and a first electronic signature 12 generated from said token 11 to the mobile terminal 4, as shown on FIG. 5.

The token 11 is non-limitatively an electronic token. Said token 11 corresponds to coded information representing the time-date of the passage, the toll infrastructure identifier and the amount to be paid.

The identification assembly is also configured such that the mobile terminal 4 is authenticated by the motorway infrastructure 3. To achieve this, the mobile terminal 4 sends at least one second electronic signature 13 generated from the token 11 to the motorway infrastructure 3 (FIG. 5).

The calculation module 14 of the server 15 of the motorway infrastructure 3 is configured to implement one of the following two actions:
if the calculation module 14 of the server 15 of the motorway infrastructure 3 deduces that the second signature 13 is generated from the token 11, the server 15 of the motorway infrastructure 3 sends a signal representing an access authorisation for the vehicle 1,
if the calculation module 14 of the server 15 of the motorway infrastructure 3 deduces that the second signature 13 is not generated from the token 11, the server 15 of the motorway infrastructure 3 sends a signal representing a refusal to allow access for the vehicle 1.

When the server 15 of the motorway infrastructure 3 sends a signal representative of an access authorisation of vehicle 1, the toll barrier 10 is raised to allow the vehicle 1 to pass.

When the server 15 of the motorway infrastructure 3 sends a signal representative of an access refusal of vehicle 1, the toll barrier 10 remains lowered to prevent access of the vehicle 1 to the motorway.

In a toll configuration without a barrier, if the server 15 of the motorway infrastructure 3 sends a signal representing refusal of access to the vehicle 1, this vehicle 1 will have to pay the amount of the toll due by another means to obtain authorisation to access the motorway.

In one embodiment, the identification assembly implements an asymmetric cryptography, preferably an elliptical curve encryption. To achieve this, the server 15 of the motorway infrastructure 3 comprises a secure memory 17 storing a private key TCKpriv of the server 15 of the motorway infrastructure 3 and a derived public key UKpub of the mobile terminal 4, and the mobile terminal 4 comprises a secure memory 18 storing a derived private key UKpriv concerning the mobile terminal 4 and a public key TCKpub concerning the server 15 of the motorway infrastructure 3. The public key TCKpub was sent to the mobile terminal 4 by a supplier server 20.

The mobile terminal 4 authenticates the motorway infrastructure 3 as follows (FIG. 5).

The transmission-reception module 5 of the mobile terminal 4 is configured to send a signal representing a unique payment identifier PAN (“Personal Account Number”). This PAN signal is sent to the server 15 of the motorway infrastructure 3.

The calculation module 14 of the server 15 of the motorway infrastructure 3 generates a token 11 representing information about the transaction to be authorised and generates the first signature 12. The first signature 12 is generated by encryption of said token 11 by the private key TCKpriv of the server of the motorway infrastructure 3, that is stored in the secure memory 18 of the server 15 of the motorway infrastructure 3.

The transmission-reception module 5 of the mobile terminal 4 then receives the token 11 and the first signature 12 sent by the server 15 of the motorway infrastructure 3.

The secure module 16 of the mobile terminal 4 decrypts the first signature 12. Decryption is made using the public key TCKpub of the server 15 of the motorway infrastructure 3 that is stored in the secure memory 18 of the mobile terminal 4.

If the decrypted token 11 corresponds to the sent token 11, the motorway infrastructure 3 is authenticated by the mobile terminal 4.

The mobile terminal 4 is then authenticated by the motorway infrastructure 3 as follows (FIG. 5).

The secure module 16 of the mobile terminal 4 generates a second signature 13. The second signature 13 is generated by encryption of said token 11 by the derived private key UKpriv concerning the mobile terminal 4 stored in the secure memory 18 of the mobile terminal 4.

The transmission-reception module 5 of the mobile terminal 4 then sends the second signature 13 to the server 15 of the motorway infrastructure 3.

After receiving the second signature 13, the calculation module 14 of the server 15 of the motorway infrastructure 3 decrypts the second signature 13 using the derived public key UKpub.

The calculation module of the server of the motorway infrastructure 3 authorises or does not authorise access of the vehicle 1 to the motorway.

If the calculation module 14 of the server 15 of the motorway infrastructure 3 deduces that the second signature 13 is generated from the token 11, the server 15 of the motorway infrastructure 3 sends a signal representing an access authorisation for the vehicle 1.

If the calculation module 14 of the server 15 of the motorway infrastructure 3 deduces that the second decrypted signature is not generated from the token 11, the server of the motorway infrastructure 3 sends a signal representing a refusal to allow access for the vehicle 1.

Furthermore, if the calculation module 14 of the server 15 of the motorway infrastructure 3 deduces that the second signature 13 is generated from the token 11, the server of the motorway infrastructure 3 sends a signal representing an OK transaction authorisation to a supplier server 20. If the calculation module 14 of the server 15 of the motorway infrastructure 3 deduces that the second signature 13 is not generated from the token 11, the server 15 of the motorway infrastructure 3 sends a signal representing a NOK transaction refusal to the supplier server.

The derived public key UKpub may be generated as follows (FIG. 5).

The public key TCKpub of the server 15 of the motorway infrastructure 3 is sent by said server 15 of the motorway infrastructure 3 to the supplier server 20.

A master public key IEKpub and a master private key IEKpriv are generated by a calculation module 23 of the supplier server 20 and stored in a secure memory 21 of the supplier server 20 (FIG. 4).

The master public key IEKpub is then sent by the supplier server 20 to the secure memory 17 of the server 15 of the motorway infrastructure 3.

Finally, the derived public key UKpub is calculated from the unique payment identifier PAN and the master public key IEKpub by the calculation module 14 of the server 15 of the motorway infrastructure 3.

The derived private key UKpriv may be generated as follows.

The unique payment identifier PAN is generated by the calculation module 23 of the supplier server 20 and then transmitted to the mobile terminal 4.

The derived private key UKpriv is calculated by the calculation module 23 of the supplier server 20 from the unique payment identifier PAN and the master private key IEKpriv.

Finally, the derived private key UKpriv is sent by the supplier server 20 to the secure memory 18 of the mobile terminal 4 by a secure communication channel separate from the transmission channel of the unique payment identifier PAN. The public key TCKpub is also sent by the supplier server 20 to the secure memory 18 of the mobile terminal 4.

The system S also comprises a degraded mode operating module 22 (FIG. 2), configured to replace the transmission-reception module 5 by an auxiliary transmission-reception module 51.

For example, if the transmission-reception module 5 configured to function with the “Bluetooth Low Energy” protocol is not activated or does not function, the degraded mode operating module 22 can replace it by an auxiliary transmission-reception module 51. The auxiliary transmission-reception module 51 can be configured to function using the NFC technology.

According to another example, if at least one of the beacons B1, B2, B3 of the motorway infrastructure 3 does not function for geopositioning, the degraded mode operating module 22 can also replace it by an auxiliary transmission-reception module 51.

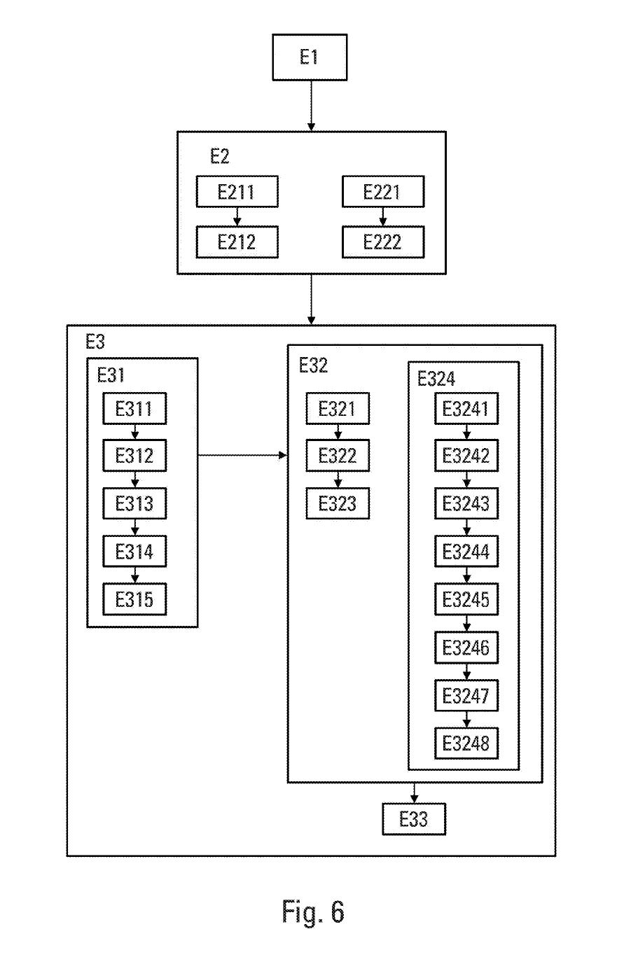

The system S implements the method comprising the following steps (FIG. 6):

an awakening step E1, implemented by the monitoring module 61 of the dedicated application 8, consisting of starting the dedicated application 8 upon reception of a first signal S1 through the transmission-reception module 5 of the mobile terminal 4, the first signal S1 being transmitted by a first beacon B1 in the toll lane 2 used by the vehicle 1;

a geopositioning step E2 of the mobile terminal 4, implemented by the geopositioning module 9 of the dedicated application 8, consisting of determining the geoposition of the mobile terminal 4, using at least the first signal S1 received from the first beacon B1.

If the geopositioning step E2 has determined a geoposition of the mobile terminal 4 in the toll lane 2 facing a toll barrier 10 in the toll lane 2 used by the vehicle 1, the method includes:

an identification step E3, implemented by the identification assembly consisting of making a user identification, the user identification generating an authorisation for the vehicle 1 to access the motorway.

According to the first embodiment, the geopositioning step E2 includes the following sub-steps:

a reception sub-step E211, implemented by the transmission-reception module 5 of the mobile terminal 4, consisting of receiving at least one second signal S2 transmitted by a second beacon B2 and a third signal S3 transmitted by a third beacon B3, the second signal S2 and the third signal S3 comprising information containing at least one identifier of the toll lane 2 and the corresponding positions of the second beacon B2 and the third beacon B3 respectively;

a calculation sub-step E212 implemented by the geopositioning module 9 of the dedicated application 8, consisting of calculating the geoposition of the mobile terminal 4 by triangulation starting from the corresponding positions of beacons B1, B2, B3 with the same identifier of the toll lane 2, said positions being deduced from the first, second and third received signals S1, S2, S3.

According to the second embodiment, the geopositioning step E2 includes the following sub-steps:

a reception sub-step E221 implemented by the transmission-reception module 5 of the mobile terminal 4, consisting of receiving a signal SA transmitted by a directional antenna of a transmission device associated with the toll lane 2 used by the vehicle 1, the directional antenna transmitting a signal SA in the toll lane 2 only, the signal SA comprising information containing at least the identifier of the toll lane 2;

a calculation sub-step E222, implemented by the geopositioning module 9 of the dedicated application 8, consisting of determining the geoposition of the mobile terminal 4, the mobile terminal 4 being geopositioned in the toll lane 2 used by the vehicle 1 when the identifier of the toll lane 2 included in the signal SA transmitted by the directional antenna corresponds to the identifier of the toll lane 2 included in the signal S1 transmitted by the first beacon B1.

The identification step E3 includes the following sub-steps:

a sub-step E31 to authenticate the motorway infrastructure 3 by the mobile terminal 4 consisting of authenticating the motorway infrastructure 3 by sending at least one token 11 and a first electronic signature 12 generated from the token 11, the token 11 and the first signature 12 being sent by the motorway infrastructure 3 to the mobile terminal 4;

a sub-step E32 to authenticate the mobile terminal 4 by the motorway infrastructure 3 consisting of authenticating the mobile terminal 4 by sending at least one second electronic signature 13 generated from the token 11, the second signature 13 being sent by the mobile terminal 4 to the motorway infrastructure 3;

an authorisation sub-step E33, implemented by the calculation module 14 of a server 15 of the motorway infrastructure 3, consisting of implementing one of the following two actions:
if the calculation module 14 of the server 15 of the motorway infrastructure 3 deduces that the second signature 13 is generated from said token 11, the server 15 of the motorway infrastructure 3 sends a signal representing an access authorisation for the vehicle 1,
if the calculation module 14 of the server 15 of the motorway infrastructure 3 deduces that the second signature 13 is not generated from said token 11, the server 15 of the motorway infrastructure 3 sends a signal representing a refusal to allow access for the vehicle 1.

The sub-step E31 in which the motorway infrastructure 3 is authenticated by the mobile terminal 4 comprises:

a first sub-step E311 to send the identifier, implemented by the transmission-reception module 5 of the mobile terminal, consisting of sending a signal representative of a unique payment identifier PAN (“personal account number”), the signal being sent to the server 15 of the motorway infrastructure 3;

a token generation sub-step E312, implemented by the calculation module 14 of the server 15 of the motorway infrastructure 3, consisting of generating a token 11 representative of information for a transaction to be authorised:

a sub-step E313 to generate a first signature, implemented by the calculation module 14 of the server 15 of the motorway infrastructure 3, consisting of generating a first signature 12 starting from the token 11 by encrypting the token 11 using a first private key TCKpriv of the server 15 of the motorway infrastructure 3, the first private key TCKpriv of the server 15 of the motorway infrastructure 3 being stored in a secure memory 17 of the server 15 of the motorway infrastructure 3;

a reception sub-step E314, implemented by the transmission-reception module 5 of the mobile terminal 4, consisting of receiving the token 11 and the first signature 12 generated by the calculation module 14 of the server 15 of the motorway infrastructure 3;

a first decryption sub-step E315, implemented by a secure module 16 of the mobile terminal 4, consisting of decrypting the first signature 12 using a public key TCKpub of the server 15 of the motorway infrastructure 3, the public key TCKpub of the server 15 of the motorway infrastructure 3 being stored in a secure memory 18 of the mobile terminal 4.

The sub-step E32 to authenticate the mobile terminal 4 by the motorway infrastructure 3 comprises:

a sub-step E321 to generate a second signature, implemented by the secure module 16 of the mobile terminal 4, consisting of generating a second signature 19 by encrypting the token 11 by a derived private key (UKpriv) concerning the mobile terminal 4;

a second send sub-step E322, implemented by the transmission-reception module 5 of the mobile terminal 5, consisting of sending the second signature 19 to the server 15 of the motorway infrastructure 3;

a second decryption sub-step E323, implemented by the calculation module 14 of the server 15 of the motorway infrastructure 3, consisting of decrypting the second signature 19 by a derived public key UKpub concerning the mobile terminal 4.

The authorisation sub-step E33 implemented by the calculation module 14 of the server 15 of the motorway infrastructure 3 also comprises:
if the calculation module 14 of the server 15 of the motorway infrastructure 3 deduces that the second signature 19 is generated from the token 11, the server 14 of the motorway infrastructure 3 sends a signal representing an OK authorisation transaction to a supplier server 20,
if the calculation module 14 of the server 15 of the motorway infrastructure 3 deduces that the decrypted second signature 19 is not generated from the token 11, the server 15 of the motorway infrastructure 3 sends a signal representing a NOK transaction refusal to the supplier server 20.

The sub-step E32 to authenticate the mobile terminal 4 by the motorway infrastructure 3 also comprises a sub-step E324 to generate the derived public key UKpub comprising:

a sub-step E3241 to send a public key TCKpub from the server 15 of the motorway infrastructure 3 by said server 15 of the motorway infrastructure 3 to a supplier server 20;

a sub-step E3242 to generate a master public key IEKpub and a master private key IEKpriv by a calculation module 23 of the supplier server 20;

a sub-step E3243 to send the master public key IEKpub by the supplier server 20 to the secure memory 17 of the server 15 of the motorway infrastructure 3;

a sub-step E3244 to calculate the derived public key UKpub from the unique payment identifier PAN and the master public key IEKpub by the calculation module 14 of the server 15 of the motorway infrastructure 3.

The sub-step E32 to authenticate the mobile terminal 4 by the motorway infrastructure 3 also comprises a sub-step E3245 to generate the derived private key UKpriv comprising:

a sub-step E3246 to generate the unique payment identifier PAN by the calculation module 23 of the supplier server 20 and to send the unique payment identifier PAN to the mobile terminal 4;

a sub-step E3247 to calculate the derived private key UKpriv by the calculation module 23 of the supplier server 20 from the unique payment identifier PAN and the master private key IEKpriv,

a sub-step E3248 to send the derived private key UKpriv and the public key TCKpub by the supplier server 20 to the secure memory 18 of the mobile terminal 4.

The method includes a degraded mode operating step, implemented by a degraded mode operating module 22, consisting of replacing the transmission-reception module 5 by an auxiliary transmission-reception module 51.

1. A motorway toll method capable of authorising access to a motorway for a vehicle of a user using a toll lane of a motorway infrastructure using a mobile terminal located in the vehicle, the motorway infrastructure comprising a plurality of toll lanes, the mobile terminal containing a transmission-reception module, a processor and a memory storing a dedicated application, the dedicated application being implemented as a background task by the processor,
characterised in that the method comprises the following steps:
a step (E1) to awaken the dedicated application when the vehicle approaches the toll lane, said awakening step being implemented by a monitoring module of the dedicated application comprising starting the dedicated application on reception of a first signal through the transmission-reception module of the mobile terminal, the first signal being transmitted by a first beacon in the toll lane used by the vehicle;
a geopositioning step of the mobile terminal at the time that the vehicle approaches the motorway infrastructure, said geopositioning step being implemented by a geopositioning module of the dedicated application and including determining the geoposition of the mobile terminal so as to geoposition the vehicle in the toll lane, using at least the first signal received from the first beacon;
if the geopositioning step has determined a geoposition of the mobile terminal in the toll lane facing a toll barrier in the toll lane used by the vehicle, the method includes:
an identification step, implemented by an identification assembly comprising making a user identification, the user identification generating an authorisation for the vehicle to access the motorway.

2. The method according to claim 1, wherein the transmission-reception module of the mobile terminal is configured to function with a protocol using the short range two-directional transmission technique known as “Bluetooth Low Energy”.

3. The method according to claim 1, wherein the first signal transmitted by the first beacon comprises information containing at least one identifier of the toll lane and the position of the first beacon.

4. The method according to claim 1, wherein the geopositioning step comprises the following sub-steps:
a reception sub-step, implemented by the transmission-reception module of the mobile terminal comprising receiving at least one second signal transmitted by a second beacon and a third signal transmitted by a third beacon, the second signal and the third signal comprising information containing at least one identifier of the toll lane and the corresponding positions of the second beacon and the third beacon respectively;
a calculation sub-step (E212) implemented by the geopositioning module (9) of the dedicated application comprising calculating the geoposition of the mobile terminal by triangulation starting from the corresponding positions of beacons with the same identifier of the toll lane, said positions being deduced from the first, second and third received signals.

5. The method according to claim 1, wherein said geopositioning step comprises the following sub-steps:
a reception sub-step implemented by the transmission-reception module of the mobile terminal, comprising receiving a signal transmitted by a directional antenna of a transmission device associated with the toll lane used by the vehicle, the directional antenna transmitting a signal in the toll lane only, the signal comprising information containing at least the identifier of the toll lane;
a calculation sub-step, implemented by the geopositioning module of the dedicated application comprising determining the geoposition of the mobile terminal, the mobile terminal being geopositioned in the toll lane used by the vehicle when the identifier of the toll lane included in the signal transmitted by the directional antenna corresponds to the identifier of the toll lane included in the signal transmitted by the first beacon.

6. The method according to claim 1, wherein the identification step comprises the following sub-steps:
a sub-step to authenticate the motorway infrastructure by the mobile terminal comprising authenticating the motorway infrastructure by sending at least one token and a first electronic signature generated from the token, the token and the first signature being sent by the motorway infrastructure to the mobile terminal,
a sub-step to authenticate the mobile terminal by the motorway infrastructure comprising authenticating the mobile terminal by sending at least one second electronic signature (13) generated from the token, the second signature (13) being sent by the mobile terminal to the motorway infrastructure;
an authorisation sub-step, implemented by the calculation module of a server of the motorway infrastructure comprising implementing one of the following two actions:
if the calculation module of the server of the motorway infrastructure deduces that the second signature is generated from said token, the server of the motorway infrastructure sends a signal representing an access authorisation for the vehicle,
if the calculation module of the server of the motorway infrastructure deduces that the second signature is not generated from said token (11), the server of the motorway infrastructure sends a signal representing a refusal to allow access for the vehicle.

7. The method according to claim 6, the sub-step in which the motorway infrastructure is authenticated by the mobile terminal comprises:
a first sub-step to send the identifier, implemented by the transmission-reception module of the mobile terminal, comprising sending a signal representative of a unique payment identifier (PAN), the signal being sent to the server of the motorway infrastructure;
a token generation sub-step, implemented by the calculation module of the server of the motorway infrastructure comprising generating a token representative of information for a transaction to be authorised:
a sub-step to generate a first signature, implemented by the calculation module of the server of the motorway infrastructure comprising generating a first signature starting from the token by encrypting the token using a first private key (TCKpriv) of the server of the motorway infrastructure, the first private key (TCKpriv) of the server of the motorway infrastructure being stored in a secure memory of the server of the motorway infrastructure;
a reception sub-step, implemented by the transmission-reception module of the mobile terminal comprising receiving the token and the first signature generated by the calculation module of the server of the motorway infrastructure;
a first decryption sub-step, implemented by a secure module of the mobile terminal comprising decrypting the first signature using a public key (TCKpub) of the server of the motorway infrastructure, the public key (TCKpub) of the server of the motorway infrastructure being stored in a secure memory of the mobile terminal.

8. The method according to claim 6, wherein the sub-step in which the mobile terminal is authenticated by the motorway infrastructure comprises:
a sub-step to generate a second signature, implemented by the secure module of the mobile terminal comprising generating a second signature by encrypting the token by a derived private key (UKpriv) concerning the mobile terminal;
a second send sub-step, sent by the transmission-reception module of the mobile terminal comprising sending the second signature to the server of the motorway infrastructure;
a second decryption sub-step, implemented by the calculation module of the server of the motorway infrastructure comprising decrypting the second signature by a derived public key (UKpub) concerning the mobile terminal.

9. The method according to claim 6, wherein the authorisation sub-step implemented by the calculation module of the server of the motorway infrastructure also comprises:
if the calculation module of the server of the motorway infrastructure deduces that the second signature is generated from the token, the server of the motorway infrastructure sends a signal representing an authorisation transaction to a supplier server,
if the calculation module of the server of the motorway infrastructure deduces that the decrypted second signature is not generated from the token, the server of the motorway infrastructure sends a signal representing a transaction refusal to the supplier server.

10. The method according to claim 6, wherein the sub-step in which the mobile terminal is authenticated by the motorway infrastructure also comprises:
a sub-step to generate the derived public key (UKpub) comprising:
a sub-step to send a public key (TCKpub) from the server of the motorway infrastructure by said server of the motorway infrastructure to a supplier server;
a sub-step to generate a master public key (IEKpub) and a master private key (IEKpriv) by a calculation module of the supplier server;
a sub-step to send the master public key (IEKpub) by the supplier server to the secure memory of the server of the motorway infrastructure;
a sub-step to calculate the derived public key (UKpub) from the unique payment identifier (PAN) and the master public key (IEKpub) by the calculation module of the server of the motorway infrastructure,
the sub-step to authenticate the mobile terminal by the motorway infrastructure also comprising:
a sub-step to generate the derived private key (UKpriv) comprising:
a sub-step to generate the unique payment identifier (PAN) by the calculation module of the supplier server and to send the unique payment identifier (PAN) to the mobile terminal;
a sub-step to calculate the derived private key (UKpriv) by the calculation module of the supplier server from the unique payment identifier (PAN) and the master private key (IEKpriv);
a sub-step to send the derived private key (UKpriv) and the public key (TCKpub) by the supplier server to the secure memory of the mobile terminal.

11. The method according to claim 1, wherein the method includes a degraded mode operating step, implemented by a degraded mode operating module comprising replacing the transmission-reception module by an auxiliary transmission-reception module.

12. A motorway remote toll system capable of authorising access to a motorway for a vehicle of a user using a toll lane of a motorway infrastructure using a mobile terminal located in the vehicle, the motorway infrastructure comprising a plurality of toll lanes, the mobile terminal containing a transmission-reception module, a processor and a memory storing a dedicated application, the dedicated application being implemented as a background task by the processor:
characterised in that the system comprises:
at least one first beacon for each toll lane, the first beacon(s) being configured to transmit a first signal;
a monitoring module of the dedicated application configured to start the dedicated application upon reception of the first signal by the transmission-reception module of the mobile terminal when the vehicle approaches the toll lane, the first signal being transmitted by the first beacon in the toll lane used by the vehicle;
a geopositioning module of the dedicated application configured to determine the geoposition of the mobile terminal when the vehicle is approaching the motorway infrastructure, so as to geoposition the vehicle in the toll lane, using at least the first signal received from the first beacon;
an identification assembly configured to identify the user if the geopositioning module has determined a geoposition of the mobile terminal in the toll lane facing a toll barrier of the toll lane used by the vehicle, identification of the user generating authorisation for the vehicle to access the motorway.

13. The system according to claim 12, wherein the transmission-reception module of the mobile terminal is configured to function with the protocol using the short range two-directional transmission technique known as “Bluetooth Low Energy”.

14. The system according to claim 12, wherein the first signal transmitted by the first beacon comprises information containing at least one identifier of the toll lane and the position of the first beacon.

15. The system according to claim 12, wherein the system further comprises:
at least one second beacon and one third beacon arranged in the motorway infrastructure, the second beacon being configured to transmit a second signal, the third beacon being configured to transmit a third signal, the second signal and the third signal comprising information containing at least one identifier of the toll lane and the positions of the second beacon and the third beacon respectively;
the geopositioning module of the dedicated application being configured to calculate the geoposition of the mobile terminal by triangulation starting from the corresponding positions of beacons with the same identifier of the toll lane.

16. The system according to claim 12, wherein the system any
comprises:
a directional antenna of a transmission device associated with the toll lane used by the vehicle, the directional antenna being configured to transmit a signal only in the toll lane, the signal comprising information containing at least the identifier of the toll lane;
the geopositioning module of the dedicated application being configured to determine the geoposition of the mobile terminal, the mobile terminal being geopositioned in the toll lane used by the vehicle when the identifier of the toll lane included in the signal transmitted by the directional antenna corresponds to the identifier of the toll lane included in the signal transmitted by the first beacon.

17. The system according to claim 12, wherein the system comprises a degraded mode operating module, configured to replace the transmission-reception module by an auxiliary transmission-reception module.
